(19) United States
(12) Patent Application Publication
(10) Pub. No.: US 2007/0280526 A1
(43) Pub. Date: Dec. 6, 2007

(54) Determining Information about Defects or Binning Defects Detected on a Wafer after an Immersion Lithography Process is Performed on the Wafer

(76) Inventors: Irfan Malik, Sunnyvale, CA (US); Somnath Nag, Saratoga, CA (US)

Correspondence Address: BAKER & MCKENZIE LLP, 1114 AVENUE OF THE AMERICAS, NEW YORK, NY, 10036, US

(21) Appl. No.: 11/420,960

(22) Filed: May 30, 2006

(51) Int. Cl. G06K 9/00

(52) U.S. Cl. 382/149

(57) ABSTRACT

Various computer-implemented methods are provided. One computer-implemented method for determining information about a defect detected on a wafer after an immersion lithography (IL) process is performed on the wafer includes comparing inspection results for the defect to data in a defect library for different types of IL defects and determining the information about the defect based on results of the comparison. One computer-implemented method for binning defects detected on a wafer after an IL process is performed on the wafer includes comparing one or more characteristics of the defects to one or more characteristics of IL defects and one or more characteristics of non-IL defects. The method also includes binning the defects having one or more characteristics that substantially match the one or more characteristics of the IL defects and the non-IL defects in different groups.

### BACKGROUND OF THE INVENTION

1. Field of the Invention

The present invention generally relates to determining information about defects or binning defects detected on a wafer after an immersion lithography (IL) process is performed on the wafer. Certain embodiments relate to comparing inspection results for a defect, which is detected on a wafer after an IL process is performed on the wafer, to data in a defect library for different types of IL defects.

2. Description of the Related Art

The following description and examples are not admitted to be prior art by virtue of their inclusion in this section.

Fabricating semiconductor devices such as logic and memory devices typically includes processing a specimen such as a semiconductor wafer using a number of semiconductor fabrication processes to form various features and multiple levels of the semiconductor devices. For example, lithography is a semiconductor fabrication process that typically involves transferring a pattern to a resist arranged on a semiconductor wafer. Additional examples of semiconductor fabrication processes include, but are not limited to, chemical-mechanical polishing, etch, deposition, and ion implantation. Multiple semiconductor devices may be fabricated in an arrangement on a semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices such as integrated circuits. However, as the dimensions of semiconductor devices decrease, inspection becomes even more important to the successful manufacture of acceptable semiconductor devices because smaller defects can cause the device to fail. For instance, as the dimensions of semiconductor devices decrease, detection of defects of decreasing size has become necessary since even relatively small defects may cause unwanted aberrations in the semiconductor devices.

Another important part of yield control is determining the cause of defects on the wafer such that the cause of the defects can be corrected to thereby reduce the number of defects on other wafers. Often, determining the cause of defects involves identifying the defect type and other characteristics of the defects such as size, shape, composition, etc. Since inspection typically only involves detecting defects on the wafer and providing limited information about the defects such as location, number, and sometimes size, defect review is often used to determine more information about individual defects than that which can be determined from inspection results. For instance, a defect review tool may be used to revisit defects detected on a wafer and to examine the defects further in some manner either automatically or manually.

Defect review typically involves generating additional information about defects at a higher resolution using either a high magnification optical system or a scanning electron microscope (SEM). The higher resolution data for the defects generated by defect review is more suitable for determining characteristics of the defects such as profile, roughness, more accurate size information, etc. Defect analysis may also be performed using a system such as an electron dispersive x-ray spectroscopy (EDS) system. Such defect analysis may be performed to determine information such as composition of the defects. Characteristics of the defects determined by inspection, review, and analysis can be used to identify the type of the defect (i.e., defect classification) and possibly a root cause of the defects. This information can then be used to monitor and alter one or more parameters of one or more semiconductor fabrication processes to reduce or eliminate the defects.

As design rules shrink, however, semiconductor manufacturing processes may be operating closer to the limitations on the performance capability of the processes. In addition, smaller defects can have an impact on the electrical characteristics of the device as the design rules shrink, which drives more sensitive inspections. Therefore, as design rules shrink, the population of potentially yield relevant defects detected by inspection grows dramatically, and the population of nuisance defects detected by inspection also increases dramatically. Therefore, more and more defects may be detected on the wafers, and correcting the processes to eliminate all of the defects may be difficult and expensive. As such, determining which of the defects actually have an effect on the electrical characteristics of the devices and the yield may allow process control methods to be focused on those defects while largely ignoring others.

Furthermore, at smaller design rules, process induced failures may, in some cases, tend to be systematic. That is, process induced failures tend to occur at predetermined design patterns often repeated many times within the design. Elimination of spatially systematic, electrically relevant defects is important because eliminating such defects can have a significant overall impact on yield. Whether or not defects will affect device characteristics and yield often cannot be determined from the inspection, review, and analysis processes described above since these processes may not be able to determine the position of the defect with respect to the electrical design.

Moreover, as design rules shrink, dramatically different technologies and processes must be used in the fabrication process in place of those processes that do not have the performance capability to achieve the dimensions and other requirements of the design rules. As different technologies and processes are introduced to the fabrication process, the sources of defects will change thereby causing changes in the types of defects that will be present on wafers. As with all semiconductor fabrication processes, prior to being used for large scale manufacturing, the defects that are caused by the processes must be identified and the relationships between the defects and the causes of those defects must be determined such that the semiconductor fabrication process can be controlled. Without such control of the defects, the fabrication process cannot be expected to produce devices with any acceptable yield. Therefore, as dramatically different technologies and processes are introduced into the semiconductor fabrication process, a significant amount of learning is typically required to identify the new defect types and their relationships with parameters of the processes. Obviously, it is desirable to acquire such learning in as short a period of time as possible to achieve rapid time-to-market and to maximize profitability of the manufacturing process.

Accordingly, it would be advantageous to develop computer-implemented methods for determining information about a defect detected on a wafer and/or for binning defects detected on the wafer after a new process is performed on the wafer, which can be used to reduce the time-to-market of devices fabricated using the new process thereby maximizing profitability of the fabrication process.

### SUMMARY OF THE INVENTION

The following description of various embodiments of computer-implemented methods is not to be construed in any way as limiting the subject matter of the appended claims.

One embodiment relates to a computer-implemented method for determining information about a defect detected on a wafer after an immersion lithography (IL) process is performed on the wafer. The method includes comparing inspection results for the defect to data in a defect library for different types of IL defects. The method also includes determining the information about the defect based on results of the comparison.

In one embodiment, the inspection results include an image of the defect, and the data includes images of the different types of the IL defects. In another embodiment, the inspection results include a signature of the defect, and the data includes signatures of the different types of the IL defects. In some embodiments, the data includes data for the different types of the IL defects for different values of parameters of the IL process. In an additional embodiment, the defect library includes data for different types of non-IL defects. In a further embodiment, the data includes defect images generated by inspection, defect images generated by review, patch images, wafer maps, pareto charts, root cause information, or some combination thereof. In another embodiment, the data includes data acquired by inspection of other wafers, data determined from output of the inspection, or some combination thereof.

In one embodiment, the information includes a classification of the defect. In another embodiment, the information includes identification of the defect as a systematic defect or a nuisance defect. In an additional embodiment, the information includes a root cause of the defect.

In one embodiment, the method includes determining one or more actions that can be taken to reduce the defect on additional wafers. In some embodiments, the method includes determining one or more actions that can be taken to increase yield of a fabrication process that includes the IL process.

In an additional embodiment, the IL process includes an exposure step during which water is in contact with the wafer. In a different embodiment, the IL process includes an exposure step during which a liquid having a refractive index (RI) greater than the RI of water is in contact with the wafer. Each of the embodiments described above may include any other step(s) of any other method(s) described herein.

Another embodiment relates to a computer-implemented method for binning defects detected on a wafer after an IL process is performed on the wafer. The method includes comparing one or more characteristics of the defects to one or more characteristics of IL defects and one or more characteristics of non-IL defects. The method also includes binning the defects having one or more characteristics that substantially match the one or more characteristics of the IL defects and the non-IL defects in different groups.

In one embodiment, the one or more characteristics of the defects include feature vectors of the defects. In another embodiment, the one or more characteristics of the defects include feature vectors of spatial signatures of the defects. In an additional embodiment, the one or more characteristics of the IL defects include the one or more characteristics of the IL defects for different values of parameters of the IL process. In one such embodiment, the one or more characteristics of the non-IL defects include the one or more characteristics of the non-IL defects for the different values of the parameters of the IL process.

In one embodiment, the one or more characteristics of the IL defects and the non-IL defects are stored as data in a defect library. In one such embodiment, the defect library includes defect images generated by inspection, defect images generated by review, patch images, wafer maps, pareto charts, root cause information, or some combination thereof. In another embodiment, the one or more characteristics of the IL defects and the non-IL defects are determined from output acquired by inspection of other wafers.

In one embodiment, the method includes binning the defects in one or more of the different groups into different sub-groups based on the one or more characteristics of the defects. In one such embodiment, the method includes classifying the defects in the different sub-groups. In another such embodiment, the method includes determining if the defects in the different sub-groups are systematic defects or nuisance defects. In a further such embodiment, the method includes determining a root cause of the defects in the different sub-groups.

In one embodiment, the method includes determining one or more actions that can be taken to reduce the defects on additional wafers. In another embodiment, the method includes determining one or more actions that can be taken to increase yield of a fabrication process that includes the IL process.

In some embodiments, the IL process includes an exposure step during which water is in contact with the wafer. In other embodiments, the IL process includes an exposure step during which a liquid having an RI greater than the RI of water is in contact with the wafer. Each of the embodiments described above may include any other step(s) of any other method(s) described herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a schematic diagram illustrating a side view of one embodiment of a carrier medium that includes program instructions executable on a processor for performing one or more embodiments described herein and one embodiment of a system configured to perform one or more embodiments described herein;

FIG. 2 is a schematic diagram illustrating a cross-sectional view of one example of a wafer during an exposure step of an immersion lithography (IL) process;

FIG. 3 is a schematic diagram illustrating one embodiment of a computer-implemented method for determining information about a defect detected on a wafer after an IL process is performed on the wafer; and

FIG. 4 is a schematic diagram illustrating one embodiment of a computer-implemented method for binning defects detected on a wafer after an IL process is performed on the wafer.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

As used herein, the term “wafer” generally refers to substrates formed of a semiconductor or non-semiconductor material. Examples of such a semiconductor or non-semiconductor material include, but are not limited to, monocrystalline silicon, gallium arsenide, and indium phosphide. Such substrates may be commonly found and/or processed in semiconductor fabrication facilities.

A wafer may include one or more layers formed upon a substrate. For example, such layers may include, but are not limited to, a resist, a dielectric material, a conductive material, and a semiconductor material. Many different types of such layers are known in the art, and the term wafer as used herein is intended to encompass a wafer including all types of such layers.

One or more layers formed on a wafer may be patterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals.

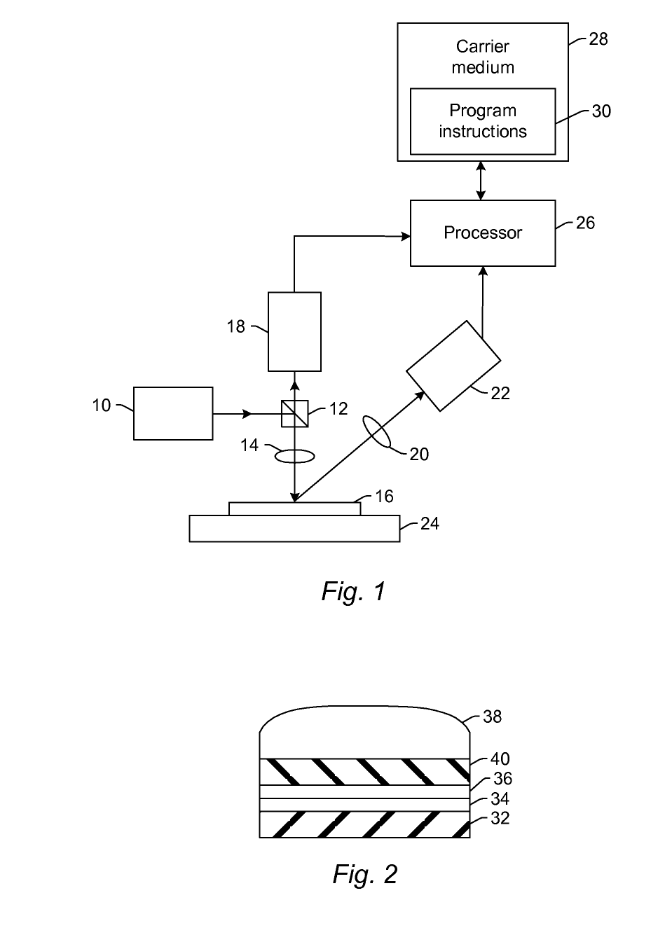

FIG. 1 illustrates one embodiment of a system configured to perform one or more embodiments of a computer-implemented method described herein. The system includes an inspection system. The inspection system is configured to generate output by inspecting a wafer. It is noted that FIG. 1 is provided herein to generally illustrate one configuration of an inspection system that may be included in the system embodiments described herein. Obviously, the inspection system configuration described herein may be altered to optimize the performance of the inspection system as is normally performed when designing a commercial inspection system. In addition, the systems described herein may be implemented using an existing inspection system (e.g., by adding functionality described herein to an existing inspection system). For some such systems, the methods described herein may be provided as optional functionality of the system (e.g., in addition to other functionality of the system). Alternatively, the system described herein may be designed “from scratch” to provide a completely new system.

The inspection system shown in FIG. 1 includes light source 10. Light source 10 may include any appropriate light source known in the art. The inspection system may also include two or more light sources (not shown). The two or more light sources may be configured similarly or differently. For example, the light sources may be configured to generate light having different characteristics (e.g., wavelength, polarization, etc.) that can be directed to a wafer at the same or different angles of incidence and at the same time or different times.

Light source 10 is configured to direct light to beam splitter 12. Beam splitter 12 is configured to direct light from light source 10 to objective 14. Objective 14 is configured to focus the light from beam splitter 12 onto wafer 16 at a substantially normal angle of incidence. However, the inspection system may be configured to direct the light to the wafer at any suitable angle of incidence. Beam splitter 12 may include any appropriate optical component known in the art. Objective 14 may include any appropriate refractive optical component known in the art. In addition, although objective 14 is shown in FIG. 1 as a single refractive optical component, it is to be understood that objective 14 may include one or more refractive optical components and/or one or more reflective optical components.

The inspection system includes a collection system that includes multiple, independent detection channels. Each detection channel is configured to collect light scattered or reflected from the wafer over a set of collection angles. In addition, although the inspection system is described further herein as including a bright field (BF) channel and a dark field (DF) channel, it is to be understood that the inspection system may include any combination of one or more detection channels (e.g., one or more BF channels and/or one or more DF channels). Moreover, the inspection system may include a number of detection channels, and output generated by all of the detection channels or fewer than all of the detection channels may be used by a processor as described further herein. The output generated by a particular combination of detection channels that is used by a processor as described further herein may be selected based on, for example, characteristics of the wafer, characteristics of the defects of interest, and characteristics of the inspection system.

In the embodiment shown in FIG. 1, light reflected from wafer 16 is collected by objective 14 and passes through beam splitter 12 to detector 18. Detector 18 may be any appropriate detector known in the art. Detector 18 may be configured to acquire pixel-level output for wafer 16. In addition, detector 18 may be an imaging detector. Therefore, the pixel-level output generated by detector 18 may include image data. As shown in FIG. 1, objective 14 is configured to collect light specularly reflected from the wafer, and detector 18 is configured to detect light specularly reflected from the wafer. Therefore, objective 14 and detector 18 form the BF channel of the inspection system. As such, the BF channel of the inspection system may be configured to generate pixel-level output for the wafer. In addition, the BF channel of the inspection system may be configured to generate pixel-level output that includes image data.

Light scattered from wafer 16 is collected by objective 20, which directs the collected light to detector 22. Objective 20 may include any appropriate refractive optical component known in the art. In addition, although objective 20 is shown in FIG. 1 as a single refractive optical component, it is to be understood that objective 20 may include one or more refractive optical components and/or one or more reflective optical components. Objective 20 may be configured to collect light scattered from the wafer at any suitable scattering angles. In addition, the scattering angles at which objective 20 is configured to collect light scattered from the wafer may be determined based on one or more characteristics (e.g., of patterned features (not shown) or defects of interest (not shown)) of the wafer.

Detector 22 may be any appropriate detector known in the art. Detector 22 may be configured to generate pixel-level output for wafer 16. In addition, detector 22 may be an imaging detector. Therefore, the pixel-level output generated by detector 22 may include image data. As shown in FIG. 1, objective 20 is configured to collect light scattered from the wafer, and detector 22 is configured to detect light scattered from the wafer. Therefore, objective 20 and detector 22 form the DF channel of the inspection system. As such, the DF channel of the inspection system may be configured to generate pixel-level output for the wafer. In addition, the DF channel of the inspection system may be configured to generate pixel-level output that includes image data.

During generation of the output by the BF and DF channels of the inspection system, wafer 16 may be disposed on stage 24. Stage 24 may include any appropriate mechanical and/or robotic assembly known in the art (e.g., a scanning stage configured to support the wafer).

The system also includes processor 26. Processor 26 may be configured to receive output generated by inspecting the wafer. For example, processor 26 may be coupled to detectors 18 and 22 such that the processor can receive pixel-level output from detectors 18 and 22. Processor 26 may be coupled to the detectors in any suitable manner known in the art (e.g., via a transmission medium (not shown) that may include “wired” and/or “wireless” portions, via electronic components (not shown) interposed between each of the detectors and the processor, etc.).

In one embodiment, the system is configured to perform a computer-implemented method for determining information about a defect detected on a wafer after an immersion lithography (IL) process is performed on the wafer. In one such embodiment, processor 26 is configured to compare inspection results for the defect to data in a defect library (not shown in FIG. 1) for different types of IL defects. The processor may be configured to compare the inspection results and the data as described further herein. The inspection results may be generated by the inspection system shown in FIG. 1. In addition, the inspection results may include output generated by the inspection system that has been processed in some manner (e.g., by the processor). For example, the inspection results that are compared to the data may include a signature that is determined by the processor from output generated by the inspection system. The inspection results may include any of the inspection results described herein. The data may include any of the data described herein. The defect library may be configured as described herein. The processor is also configured to determine the information about the defect based on results of the comparison. The processor may determine the information as described herein. The information may include any of the information described herein. The processor may also be configured to perform any other step(s) of any other method(s) described herein.

In another embodiment, the system is configured to perform a computer-implemented method for binning defects detected on a wafer after an IL process is performed on the wafer. In one such embodiment, processor 26 is configured to compare one or more characteristics of the defects to one or more characteristics of IL defects and one or more characteristics of non-IL defects. The one or more characteristics of the defects may include any of the characteristic(s) described herein. The one or more characteristics of the IL defects and the non-IL defects may include any of the characteristic(s) described herein. The processor may be configured to compare the one or more characteristics of the defects to the one or more characteristics of the IL defects and the non-IL defects as described herein. In such an embodiment, the processor is also configured to bin the defects having one or more characteristics that substantially match the one or more characteristics of the IL defects and the non-IL defects in different groups. The processor may be configured to bin the defects as described further herein. The processor may also be configured to perform any other step(s) of any other method(s) described herein.

Processor 26 may take various forms, including a personal computer system, mainframe computer system, workstation, image computer, parallel processor, or any other device known in the art. In general, the term “computer system” may be broadly defined to encompass any device having one or more processors, which executes instructions from a memory medium.

The inspection system shown in FIG. 1 may also include any other suitable components (not shown) known in the art. Furthermore, the inspection system shown in FIG. 1 may be replaced with a commercially available inspection system such as the 2360, 2365, 2371, 23xx, and 28xx systems that are available from KLA-Tencor, San Jose, Calif. The embodiment of the system shown in FIG. 1 may be further configured as described herein. In addition, the system may be configured to perform any other step(s) of any of the method embodiment(s) described herein. The embodiment of the system shown in FIG. 1 has all of the advantages of the method embodiments described herein.

FIG. 1 also illustrates one embodiment of carrier medium 28 that includes program instructions 30 executable on processor 26 for performing a method for determining information about a defect detected on wafer 16 after an IL process is performed on the wafer. The method includes comparing inspection results for the defect to data in a defect library for different types of IL defects. The inspection results may be generated by the inspection system shown in FIG. 1. In addition, the inspection results may include output generated by the inspection system that has been processed in some manner. For example, the inspection results that are compared to the data may include a signature that is determined from output generated by the inspection system. The inspection results may include any of the inspection results described herein. The data may include any of the data described herein. The defect library may be configured as described herein. The inspection results for the defect may be compared to the data in the defect library as described herein. The method also includes determining the information about the defect based on results of the comparison. The information may be determined as described herein. The information may include any of the information described herein. In addition, the method for which program instructions 30 are executable may include any other step(s) of any other method(s) described herein.

In addition, or alternatively, carrier medium 28 includes program instructions 30 executable on processor 26 for performing a method for binning defects detected on a wafer after an IL process is performed on the wafer. The method includes comparing one or more characteristics of the defects to one or more characteristics of IL defects and one or more characteristics of non-IL defects. The one or more characteristics of the defects may include any of the characteristic(s) of the defects described herein. The one or more characteristics of the IL defects and the non-IL defects may include any of the characteristic(s) described herein. Comparing the characteristic(s) of the defects to the characteristic(s) of the IL defects and the non-IL defects may be performed as described herein. The method also includes binning the defects having one or more characteristics that substantially match the one or more characteristics of the IL defects and the non-IL defects in different groups. Binning the defects may be performed in this method as described herein. In addition, this method for which program instructions 30 are executable may include any other step(s) of any other method(s) described herein.

Program instructions 30 implementing methods such as those described herein may be transmitted over or stored on carrier medium 28. The carrier medium may be a transmission medium such as a wire, cable, or wireless transmission link. The carrier medium may also be a storage medium such as a read-only memory, a random access memory, a magnetic or optical disk, or a magnetic tape.

The program instructions may be implemented in any of various ways, including procedure-based techniques, component-based techniques, and/or object-oriented techniques, among others. For example, the program instructions may be implemented using Matlab, Visual Basic, ActiveX controls, C, C++ objects, C#, JavaBeans, Microsoft Foundation Classes (“MFC”), or other technologies or methodologies, as desired.

As described above, the program instructions may be executable on processor 26. Therefore, the program instructions may be executable on a processor coupled to an inspection system. However, the program instructions may be executable on a processor that is not coupled to an inspection system. In this manner, the carrier medium and the processor may be configured as a “stand alone” system. The stand alone system may, however, be configured to acquire the inspection results described above from an inspection system (e.g., from a processor or storage medium (not shown) of the inspection system). The stand-alone system may acquire the inspection results in any manner known in the art (e.g., via a transmission medium that may include “wired” and/or “wireless” portions). In this manner, the transmission medium may serve as a data link between the processor and the inspection system. Therefore, the methods described herein may or may not include acquiring the inspection results by performing inspection of a wafer. In other words, the methods described herein may be performed by a system that does not include an inspection system.

193 nm lithography technology is at its end of life after the 65 nm technology node. New lithography techniques need to be considered for use at the 45 nm technology node. 193 nm IL, 157 nm lithography, and extreme ultraviolet (EUV) lithography to name a few lithography approaches were considered. However, 193 nm IL quickly emerged as the front runner for use at the 45 nm technology node.

In general, IL replaces air with a liquid (e.g., water) as the medium between the lens and the wafer. For example, FIG. 2 shows a wafer during an exposure step of an IL process. In this example, wafer 32 is disposed in the exposure tool (not shown) during the exposure step. Resist 34 is formed on wafer 32. Resist 34 may include any appropriate resist known in the art. One or more different layers (not shown) such as one or more dielectric layers, one or more conductive layers, one or more semiconductor layers, etc., some of which may be patterned, may be formed between wafer 32 and resist 34. Top coat 36 may be formed on resist 34. Top coat 36 may include any appropriate top coat known in the art. Unlike conventional lithography processes in which air is disposed between the wafer and lens 38 of the exposure tool, in the exposure step of an IL process, liquid 40 is disposed between and in contact with the uppermost layer on the wafer (e.g., top coat 36) and the lowermost surface of lens 38. Liquid 40 may be water. Alternatively, liquid 40 may be a liquid having a refractive index (RI) greater than the RI of water.

IL is advantageous for a number of reasons. For example, the increased RI, and the resulting option to use higher numerical aperture (NA) optics, gives lithographers the ability to print smaller features or to print features with increased process window (e.g., depth of focus (DOF)) for the existing processes amongst a host of other performance benefits. However, IL also has some disadvantages. For example, introduction of water or other liquid to the wafer during the exposure step of the IL process brings new challenges in materials, process development, and defectivity. IL defectivity has become one of the most important challenges gating the adoption of IL for the 45 nm technology node. Introduction of new materials and their interactions are the chief contributors in IL defectivity. New defect types and defect formation mechanisms have emerged that need exploration. The embodiments described herein can advantageously be used to perform such exploration.

One embodiment relates to a computer-implemented method for determining information about a defect detected on a wafer after an IL process is performed on the wafer. The defect may be detected on the wafer using an inspection system such as that described above. In addition, although embodiments of this method are described herein with respect to “a defect” detected on a wafer, it is to be understood that this method may be performed for more than one defect detected on the wafer (e.g., some or all of the defects detected on the wafer). Furthermore, this method may be performed for one defect in a group of defects (e.g., one defect binned into a group of defects using a method described herein), and the information may be assigned to all of the defects in the group.

The IL process may be performed on the wafer as described above. For example, the IL process may include an exposure step during which water is in contact with the wafer. Alternatively, the IL process may include an exposure step during which a liquid having an RI greater than the RI of water is in contact with the wafer. For example, the liquid may be oil or a liquid having an RI in the deep ultraviolet (DUV) spectrum greater than about 1.35. The IL process may include any other steps known in the art.

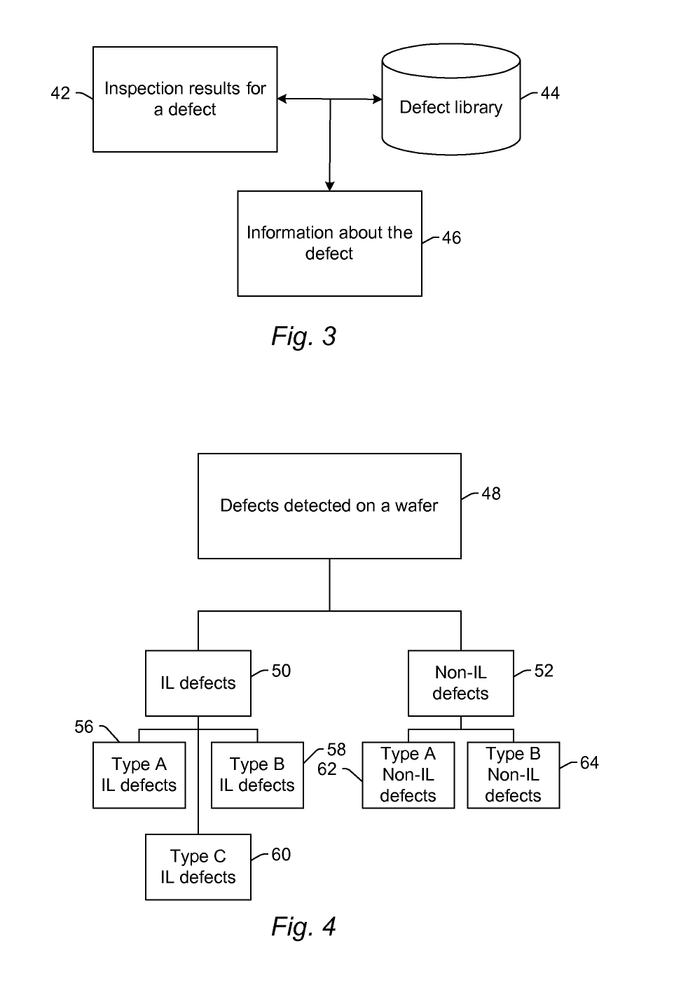

The method includes comparing inspection results for the defect to data in a defect library for different types of IL defects. For example, as shown in FIG. 3, the method may include comparing inspection results 42 to data in defect library 44 for different types of IL defects. Defect library 44 may also include data for different types of non-IL defects. In this manner, the method may include comparing the inspection results for the defect to data in the defect library for different types of IL defects and different types of non-IL defects. “IL defects” may be generally defined as defects that are caused by a defect formation mechanism that is unique to the IL process. In other words, non-IL defects can be generally defined as defects that are not uniquely caused by an IL process-related defect formation mechanism. For example, non-IL defects may also be detected on a wafer after a non-IL process (e.g., a conventional lithography process). In another example, “random defects” may be generally defined as defects that are attributable to some random defect causing mechanism such as contamination in the environment of the IL tool. Random defects may be IL defects or non-IL defects depending on the mechanism that causes the random defects.

Defect library 44 may be configured as a data structure that includes data associated with different types of IL defects. For example, the defect library may be configured as a “gallery” of defect types that are specific to the IL process. In addition, defect library 44 may be configured as a database that is searchable. In one such example, the inspection results for the defect may be used to search the database by comparing the inspection results to the data to determine if the inspection results for the defect substantially match the data for any of the different types of IL defects. Therefore, the inspection results and the data may have substantially the same form. For example, in one embodiment, the inspection results include an image of the defect, and the data includes images of the different types of the IL defects. The images of the defect and the different types of the IL defects may include any suitable images such as patch images and defect images generated by inspection. In another embodiment, the inspection results include a signature of the defect, and the data includes signatures of the different types of the IL defects. The signatures of the defect and the different types of the IL defects may include any suitable type of signature such as sets of feature vectors for the defect and the different types of the IL defects. In addition, as described further herein, the defect library may include different types of data for each of the different types of IL defects. In this manner, the defect library may be used with different types of inspection results that may be generated by different inspection systems. The defect library may also include any of the above-described data for different types of non-IL defects.

The inspection results may include data that has been determined from output generated by inspection of the wafer. The inspection results may be acquired from an inspection system (e.g., from the processor of the inspection system, which may be configured as described above). For example, the inspection system may generate output that includes an image of the defect or a signature of the defect. In this manner, the inspection results used in the method may include inspection results “as produced” by an inspection system. In a different embodiment, the inspection results may be generated by the method. For example, the method may include generating an image of the defect from output generated by an inspection system. In another example, the method may include determining a signature of the defect from output generated by an inspection system and using the signature as the inspection results.

Inspection results for the same type of defect may be somewhat different depending on the actual values of the parameters of the IL process that is performed on the wafer. In one embodiment, the data in the defect library includes data for the different types of the IL defects for different values of parameters of the IL process. The different values of the parameters of the IL process may include, for example, different values of parameters of the material properties (e.g., contact angle, photo-acid generator (PAG) leaching (via transport of PAG through the top coat, water passage through the top coat, etc.), quencher leaching, amine leaching, etc., or some combination thereof), different values of parameters of the exposure tool or “scanner” (e.g., nozzle design, shot size, scan speed, pre-rinse parameters, post-rinse parameters, fluid flow rate, etc., or some combination thereof), different values of parameters of the developer or “lithography track” (e.g., spray configuration parameters, shower configuration parameters, developer solution, rinse parameters, etc., or some combination thereof), or some combination thereof.

The different values of the parameters of the IL process for which the data for the different types of the IL defects are included in the defect library may span an entire parameter space for the IL process. In other words, the different values of the parameters of the IL process may include all possible values of the parameters. For instance, the different values of the parameters of the IL process may span an entire process window for the IL process. In addition, the different values of the parameters of the IL process may span a parameter space that includes and exceeds the process window for the IL process.

In one example, data in the defect library may be generated by performing the IL process on different wafers with different parameters of the IL process. In one such example, the temperature of the liquid in contact with the wafer during the exposure step of the IL process may be different for different IL processes performed on different wafers. In this manner, if the same type of defect is detected on more than one wafer, data for that type of defect detected on different wafers may be associated with the different temperatures of the liquid. Data for the different types of IL defects may be determined for different values of any other parameter of the IL process in a similar manner. In some embodiments, the data in the defect library includes data for different types of non-IL defects for different values of the parameters of the IL process. The data for the non-IL defects for different values of the parameters of the IL process may be determined as described above.

The data in the defect library may also include any other suitable data for the different types of the IL defects (and optionally any other suitable data for the different types of the non-IL defects). For instance, in one embodiment, the data in the defect library includes defect images generated by inspection, defect images generated by review, patch images, wafer maps, pareto charts, root cause information, or some combination thereof. The defect images generated by inspection may be generated by an inspection system described herein. The defect images generated by review may be generated by any type of defect review system known in the art (e.g., a scanning electron microscope (SEM) or a high-magnification optical system). The patch images may be generated by an inspection system or a defect review system. The wafer maps may be generated by a processor coupled to an inspection system or by the method embodiments described herein. For example, a wafer map may be generated by plotting output generated by inspection that is responsive to defects detected on the wafer as a function of position on the wafer. The pareto charts may include any suitable type of pareto chart known in the art. The root cause information may include any suitable type of root cause information, which may be determined using any system or method known in the art. In addition, the root cause information may be determined by the method embodiments described herein. For instance, output generated by inspection (possibly in combination with output generated by review) may be used in combination with information about the IL process (possibly in combination with information about the wafer history) to determine a root cause of the defect. The root cause information may also be determined experimentally or empirically (e.g., using modeling or based on a priori knowledge).

In another embodiment, the data in the defect library for the different types of the IL defects includes data acquired by inspection of other wafers, data determined from output of the inspection, or some combination thereof. The data in the defect library for the different types of the non-IL defects may also include data acquired by inspection of other wafers, data determined from output of the inspection, or some combination thereof. For example, as described above, the data may include images acquired by inspection of other wafers, data such as signatures determined from output of the inspection, other data such as pareto charts and wafer maps determined from output of the inspection, or some combination thereof. In addition, data in the defect library for different types of defects for different values of parameters of the IL process may be acquired using process window qualification (PWQ) type methods and systems such as those described in commonly assigned U.S. patent application Ser. No. 11/314,813 by Kekare et al. filed Dec. 20, 2005, which is incorporated by reference as if fully set forth herein.

The method also includes determining the information about the defect based on results of the comparing step. For example, as shown in FIG. 3, information about the defect 46 may be determined based on results of the comparing step. In one example, if the inspection results for the defect substantially match the data for one of the types of the IL defects, the defect may be determined to be an IL defect. In contrast, if the inspection results for the defect substantially match the data for one of the types of the non-IL defects, the defect may be determined to be a non-IL defect. In addition, as described above, the data in the defect library may include data for different types of defects for different values of the parameters of the IL process. Therefore, the probability that the inspection results for the defect will substantially match the data for one of the types of defects may be relatively high. However, if the inspection results for the defect do not substantially match the data for any of the types of defects in the defect library, the defect may be indicated as a “new” or “unknown” type of defect in the results of the method. Such “new” or “unknown” types of defects may also be selected by the method for defect review such that additional information about these defects can be acquired. Therefore, the defect library described herein may be used to provide classification of defects detected on a wafer as IL defects, non-IL defects, or unknown defects. In this manner, the information about the defect may include the type of the defect.

The inspection results for the defect may be determined to substantially match the data for one of the types of the defects if the probability that the inspection results and the data for the one type of defect are an exact match meets some predetermined criteria (e.g., a probability of about 90%, a probability of about 95%, etc.). The predetermined criteria may be selected by a user or may be determined prior to use of the method embodiments described herein. The predetermined criteria may vary depending on the type of defect. For example, some defect types may have one or more characteristics that are substantially the same from wafer-to-wafer or from process-to-process (e.g., lot-to-lot). Therefore, the predetermined criteria for determining a match to those defect types may be relatively high while the predetermined criteria for defect types that exhibit variability from wafer-to-wafer or from process-to-process may be relatively low.

If the inspection results for the defect substantially match the data for one of the types of IL defects, the information about the defect may be information in the defect library associated with that type of the IL defect. In one embodiment, the information includes a classification of the defect. For example, if the inspection results for the defect (e.g., a signature of the defect) substantially match data for one of the types of IL defects (e.g., a signature of the type of IL defect), the defect may be assigned the classification associated with that type of IL defect. The classification may include any suitable indicia (e.g., a number or a text string).

In another embodiment, the information about the defect includes a root cause of the defect. In one such example, if inspection results for the defect (e.g., an image of the defect) substantially match data for one of the types of IL defects (e.g., an image of the type of IL defects), the root cause of the defect may be determined to be the root cause associated with that type of the IL defects. In this manner, the methods described herein may include defect source analysis (DSA) using stored defect information (i.e., data in the defect library).

In an additional embodiment, the information includes identification of the defect as a systematic defect or a nuisance defect. A “systematic defect” may be generally defined as a pattern dependent (or a design dependent) defect. In other words, patterns formed on a wafer that are marginal in some manner (e.g., due to marginalities in the design or due to marginalities produced by interactions between the design and the process) may systematically produce defects at each location (or at least some locations) on the wafer at which the patterns are formed. Therefore, systematic defects may be “yield relevant defects.” In contrast, “nuisance defects” may be generally defined as actual defects that are not relevant for purposes of controlling the process or predicting yield.

In one such embodiment, if the inspection results for the defect (e.g., information about the pattern proximate to the defect) substantially match data for one of the types of defects (e.g., information about the pattern proximate to the type of defects), the defect may be determined to be a systematic defect if that type of defect was also determined to be a systematic defect, or the defect may be determined to be a nuisance defect if that type of defect was determined to be a nuisance defect.

Alternatively, the inspection results for the defect (e.g., information about the pattern proximate to the defect or information about the location of the defect with respect to the design) may be used to determine if the defect is a systematic defect or a nuisance defect. Determining if the defect is a systematic defect or a nuisance defect in this manner may be performed as described in commonly assigned U.S. Patent Application Ser. Nos. 60/737,947 by Zafar et al. filed Nov. 18, 2005 and 60/738,290 by Kulkarni et al. filed Nov. 18, 2005, both of which are incorporated by reference as if fully set forth herein. The embodiments described herein may include any step(s) of any method(s) described in these patent applications.

If the defect is determined to be a systematic defect, the information about the defect determined by the method embodiments described herein may also include information about the pattern formed on the wafer proximate to the defect (i.e., the context information about the defect) or the location of the defect on the wafer (e.g., such that the context information for the defect can be determined from the design and layout of the pattern being formed on the wafer).

In some embodiments, the method includes determining one or more actions that can be taken to reduce the defect on additional wafers. The information about the defect determined by the method embodiments described herein may be used to determine the one or more actions. For example, the classification or the root cause of the defect determined by the method embodiments described herein may be used to determine how one or more parameters of the IL process can be altered to reduce the defect on additional wafers. In this manner, the method may automatically determine how one or more parameters of the IL process can be altered to reduce the defect on additional wafers. “Reducing the defect on additional wafers” may include reducing the number of the defect present on additional wafers (and even substantially eliminating the presence of the defect on additional wafers) and/or reducing the severity of the defect on additional wafers (e.g., by altering one or more parameters of the IL process to alter one or more characteristics such as size of the defect).

In one example, as described above, data in the defect library may include data for different types of defects for different values of parameters of the IL process. Therefore, the information about the defect determined by the method may include the value(s) of the parameter(s) of the IL process associated with the type of defect for which data substantially matches the inspection results for the defect. The value(s) of the parameter(s) of the IL process included in the information may be compared to the process window for the parameter(s) of the IL process, and if the value(s) of the parameter(s) are outside of the process window, the one or more actions determined by the method may include altering the value(s) of the parameter(s) such that the value(s) of the parameter(s) are within the process window when the IL process is performed on additional wafers.

In another example, as described further above, the information may include a root cause of the defect. The method may include determining the one or more actions that can be taken to reduce the defect on additional wafers based on the root cause information. For example, the method may compare the root cause information to a data structure (such as the defect library, a database, a look up table, etc.) in which different types of root causes are associated with one or more actions that can be taken to reduce the number or severity of the defects associated with the root causes. In one such example, the root cause of particle type IL defects on the wafer may be contamination in the subsystem used to dispense the liquid, which is present on the wafer during the exposure step, onto the wafer. In this manner, one action that may be associated with this root cause in the data structure may be “flush the dispense subsystem.”

If multiple actions are associated with a single root cause, the actions may each be associated with (or assigned) a priority in which the actions are to be taken. The priority may be determined based on the probability that the action will reduce the defect on additional wafers. For example, in the root cause example described above, the action with the highest priority may be “flush the dispense subsystem” and an action with a lower priority may be “replace liquid supply.” In this manner, if the highest priority action is selected by the method and performed (e.g., automatically) by the method or by a user, and the same type of defect is identified by the method on additional wafers, the method may determine that a lower priority action may be performed. The classification of the defect may be used in a similar manner to determine the one or more actions that can be taken to reduce the defect on additional wafers.

In another embodiment, the method includes determining one or more actions that can be taken to increase yield of a fabrication process that includes the IL process. In some instances, the one or more actions that can be taken to reduce the defect on additional wafers and that may be determined as described above may also be one or more actions that increase yield of the fabrication process. For example, reducing the number of defects on a wafer often results in increased yield. However, the information about the defect may be used to determine one or more actions that will specifically increase yield.

In one such example, information about defects detected on the wafer that includes an identification of the defects as systematic defects or nuisance defects may be used to determine the one or more actions that will increase yield of the fabrication process. In particular, as described above, systematic defects may be defects that are caused by marginalities in the design of the pattern being formed on the wafer or interactions between the design and the process. In addition, the systematic defects may be further separated as described above into systematic defects that are yield relevant systematic defects and systematic nuisance defects. For example, systematic nuisance defects may include defects that are caused by the marginalities described above but occur at “cold spots” or non-critical areas (e.g., dummy structures, dummy fill areas, etc.) of the design and therefore have little or no yield impact. Therefore, the one or more actions that can be taken to increase yield of the fabrication process and that will have the most effect on the yield may be actions that will reduce the yield relevant systematic defects. These one or more actions may be determined as described above.

Since these actions will most likely have the largest impact on yield of the fabrication process, these systematic defects may be reduced or eliminated and then other actions may be taken to further increase yield. For example, one or more actions may be taken to reduce the yield relevant systematic defects on the wafer, and one or more additional actions may be determined that can be taken to further increase yield of the fabrication process. These one or more additional actions may include, for example, one or more actions that will reduce the random IL defects caused by the IL process since the random defects may also reduce yield of the fabrication process but perhaps not to the degree that the systematic defects will reduce yield. Each of the embodiments of the method described above may include any other step(s) of any other method(s) described herein.

The embodiments of the method described above have a number of advantages. For example, the defect library can be used to track defects, detected on wafers after an IL process is performed on the wafers, as a function of resist, fluid material properties, scanner parameters, developer parameters, or any combination thereof. For example, the defect library can be used to determine, or acquire knowledge about, defectivity versus material properties such as contact angle, bubble formation, PAG leaching (e.g., via transport of PAG through the top coat, water passage through the top coat, etc.), resist properties, top coat properties, effects of water or other liquid on the resist and top coat (e.g., due to the nature of the resist and the top coat surface), quencher leaching, amine leaching, etc., or some combination thereof. In another example, the defect library may be used to determine, or acquire knowledge about, defectivity versus scanner parameters such as nozzle design, shot size, scan speed, pre-rinse parameters, post-rinse parameters, fluid flow rate, etc., or some combination thereof. In an additional example, the defect library may be used to determine, or acquire knowledge about, defectivity versus developer parameters such as spray configurations, shower configurations, developer solution, rinse parameters, etc., or some combination thereof. Furthermore, IL defectivity is relatively complicated due to the complex interaction of parameters such as resist, top coat, scanner, scan parameters, and fluid that result in complicated defect types. In addition, changes in any of these parameters can lead to significant changes in IL defectivity. In addition, as described herein, the defect library may include defect and patch images (e.g., inspection images and/or review images), wafer maps, pareto charts, and root cause information.

The defect library can, therefore, be useful for the IL technology ramp at the 65 nm and 45 nm technology nodes. For instance, the defect library can be used to drive down the defectivity of the IL process, reduce the learning curve, and increase the yield performance of the IL process at each user site. In one such example, the embodiments described herein can be used to acquire knowledge about the formation, control, and characterization of one or more defect mechanisms in the IL process. In addition, the embodiments described herein can be used to acquire knowledge about how the liquid in contact with the wafer during the exposure step affects the resist, which can be used to acquire knowledge about immersion specific resist defectivity that can be used to develop new materials for the IL process. Furthermore, the embodiments described herein can be used to examine the compatibility of next generation fluids (e.g., liquids having an RI greater than the RI of water), resists, and top coats by determining the effect that the interactions of the liquids and the resists and top coats have on defectivity.

Such uses of the defect library are particularly advantageous for the IL process since there are many challenges in driving down and understanding defectivity of the IL process. For instance, the IL process introduces new defect types that have not been defectivity issues in non-immersion lithography processes. In addition, there is limited industry wide knowledge about the defectivity of the IL process. Furthermore, the IL process involves new types of materials such as resist and top coat materials that have not been previously used in lithography processes. As such, the new materials, with the additional complexity of the interaction of the materials with a liquid such as water, pose challenges to establishing and controlling the defectivity of the IL process.

Moreover, until now, a defect library or other data structure that can be used in the method embodiments described herein simply did not exist. Instead, only gross defects were being identified and examined to determine the potential of IL processes as solutions for the 65 nm and 45 nm technology nodes. However, such gross defect identification and examination is not suitable for the uses of the embodiments described herein including enabling a new process like IL to be ramped from development to large scale manufacturing. In particular, the embodiments described herein can be used for line monitoring and engineering analysis of the IL process in both development and manufacturing.

Another embodiment relates to a computer-implemented method for binning defects detected on a wafer after an IL process is performed on the wafer. The defects may be detected on the wafer using an inspection system such as that described above. In addition, although embodiments of this method are described herein with respect to “defects” detected on a wafer, it is to be understood that this method may be performed for more than one defect detected on the wafer (e.g., some or all of the defects detected on the wafer). The method is performed after an IL process and an inspection process have been performed on the wafer. The method may also be performed after a defect review process (e.g., SEM review) has been performed on the wafer.

The IL process may be performed on the wafer as described above. For example, the IL process may include an exposure step during which water is in contact with the wafer. Alternatively, the IL process may include an exposure step during which a liquid having an RI greater than the RI of water is in contact with the wafer. For example, the liquid may be oil or a liquid having an RI in the DUV spectrum greater than about 1.35. The IL process may include any other steps known in the art.

The method includes comparing one or more characteristics of the defects to one or more characteristics of IL defects and one or more characteristics of non-IL defects. The one or more characteristics may be determined from output generated by inspection of the wafer and/or output generated by defect review of the wafer. In one embodiment, the one or more characteristics of the defects include feature vectors of the defects. The feature vectors of the defects may include feature vectors of the defects themselves as well as feature vectors of the background of the defects. The feature vectors may be determined using any appropriate algorithm and/or method known in the art. In another embodiment, the one or more characteristics of the defects include feature vectors of spatial signatures of the defects. For instance, the feature vectors may be determined using spatial signature analysis (SSA) of inspection results for the defects or some other output responsive to the defects. Examples of SSA methods and systems that may be used in the embodiments described herein are illustrated in commonly assigned U.S. Pat. Nos. 5,991,699 to Kulkarni et al., 6,718,526 to Eldredge et al., and 7,006,886 to Huet et al., which are incorporated by reference as if fully set forth herein. The embodiments described herein may include any step(s) of any of the method(s) described in these patents.

In another embodiment, the one or more characteristics of the IL defects include the one or more characteristics of the IL defects for different values of parameters of the IL process. In one such embodiment, the one or more characteristics of the non-IL defects include the one or more characteristics of the non-IL defects for the different values of the parameters of the IL process. These one or more characteristics of the different types of defects may be determined as described above. The one or more characteristics of the different types of defects may include any of the characteristic(s) described herein such as feature vectors of the different types of defects and feature vectors of spatial signatures of the defects. In an additional embodiment, the one or more characteristics of the IL defects and the non-IL defects are determined from output acquired by inspection of other wafers. The one or more characteristics of the different types of defects may be acquired in this manner as described further herein.

In another embodiment, the one or more characteristics of the IL defects and the non-IL defects are stored as data in a defect library. The defect library may be configured as described above. For example, in one embodiment, the defect library includes defect images generated by inspection, defect images generated by review, patch images, wafer maps, pareto charts, root cause information, or some combination thereof. This data or information may be acquired as described herein.

The method also includes binning the defects having one or more characteristics that substantially match the one or more characteristics of the IL defects and the non-IL defects in different groups. For example, as shown in FIG. 4, defects detected on a wafer 48 may be binned into different groups 50 and 52. Group 50 includes defects detected on the wafer 48 having one or more characteristics that substantially match the one or more characteristics of the IL defects. Group 52 includes defects detected on the wafer 48 having one or more characteristics that substantially match the one or more characteristics of the non-IL defects.

In this manner, immersion-based defects may be separated from other defects such as non-IL defects or “dry defects” on the wafer by an automated algorithm configured to implement this method. This method may, therefore, perform functions similar to those performed by the integrated defect organizer (iDO) that is available from KLA-Tencor. In addition, the configuration of the iDO may be altered to perform this method. The IL defects or water-related defects may be binned in one group that includes multiple classes of defects such as bubble-related defects and water marks such as gross bridging defects, single bridge defects, stringers, residue, line slimming, and line thickening.

The one or more characteristics of the defects may be determined to substantially match the one or more characteristics of one of the types of the defects if the probability that the one or more characteristics of the defects and the one or more characteristics of the one type of defect are an exact match meets some predetermined criteria (e.g., a probability of about 90%, a probability of about 95%, etc.). The predetermined criteria may be selected by a user or may be determined prior to use of the method embodiments described herein. The predetermined criteria may vary depending on the type of defect. For example, some defect types may have one or more characteristics that are substantially the same from wafer-to-wafer or from process-to-process (e.g., lot-to-lot). Therefore, the predetermined criteria for determining a match for those defect types may be relatively high while the predetermined criteria for defect types that exhibit variability from wafer-to-wafer or from process-to-process may be relatively low.

In some embodiments, the method includes binning the defects in one or more of the different groups into different sub-groups based on the one or more characteristics of the defects. For example, as shown in FIG. 4, defects in group 50 that are determined to have one or more characteristics that substantially match the one or more characteristics of the IL defects may be binned into sub-groups 56, 58, and 60. In addition, defects in group 52 that are determined to have one or more characteristics that substantially match the one or more characteristics of the non-IL defects may be binned into sub-groups 62 and 64. Therefore, as shown in FIG. 4, each of the groups of defects may be binned into different numbers of sub-groups. In addition, some of the groups of defects may not be binned into sub-groups at all.

The sub-groups may include defects that have one or more characteristics that are substantially the same. For example, the defects may be binned into sub-groups using a “Defects Like Me” function in which one or more features of a selected defect are used to search for other defects that are similar to the selected defect. The “Defects Like Me” function is described in detail in commonly assigned U.S. patent application Ser. No. 11/005,658 by Wu et al. filed Dec. 7, 2004, which is incorporated by reference as if fully set forth herein. The embodiments described herein may include any step(s) of any of the method(s) described in this patent application. In this manner, the number of sub-groups into which the defects are binned may vary depending on the number of defects in the groups that have different characteristic(s). In addition, the sub-groups may include defects that have one or more characteristics that are substantially the same regardless of the locations of the defects on the wafer. Therefore, binning the defects into sub-groups may be performed based on the one or more characteristics of the defects, but not the locations of the defects on the wafer.

The one or more characteristics that are used to bin the defects into sub-groups may include any of the characteristic(s) described herein. For example, the one or more characteristics that are used to bin the defects into sub-groups may include spatial signatures that can be used to bin different types of defects (such as particles around the edge of the wafer, bubbles on the edge of wafers, diagonal lines across the wafer for water marks, top left clusters of water mark defects, and top right clusters of particles) into different sub-groups. In addition, the defects in the groups may be binned into sub-groups using rule-based binning algorithms and/or methods. Examples of suitable rule-based binning methods are illustrated in commonly assigned U.S. patent application Ser. No. 10/954,968 by Huet et al. filed Sep. 30, 2004, which is incorporated by reference as if fully set forth herein. The one or more characteristics that are compared to bin the defects into groups may be different than or the same as the one or more characteristics that are compared to bin the defects into sub-groups.

As shown in FIG. 4, each of the different sub-groups may include defects that are one type of the defects included in the groups. For example, as shown in FIG. 4, sub-groups 56, 58, and 60 include Type A IL defects, Type B IL defects, and Type C IL defects, respectively. In addition, sub-groups 62 and 64 include Type A non-IL defects and Type B non-IL defects, respectively. In this manner, the defects may be grouped into sub-groups without determining exactly what type of defects that the defects are and without determining additional information about the defects.

In one embodiment, the method includes classifying the defects in the different sub-groups. For example, as described above, the defects may be separated into sub-groups such that each of the defects in a sub-group has substantially the same one or more characteristics. In this manner, each sub-group may correspond to a different defect classification. In one such embodiment, the defects in each sub-group may be classified collectively as a sub-group using either the one or more characteristics or any other information about one defect in the sub-group or the one or more characteristics or any other information about some or all of the defects in the sub-group (e.g., some value of the one or more characteristics of some or all of the defects in the sub-group such as a mean and/or standard deviation). In addition, the one or more characteristics used to classify the defects in each sub-group may include mean range attributes such as those determined by segmented auto-thresholding (SAT). Examples of methods and systems configured for SAT are illustrated in commonly assigned U.S. Pat. No. 6,781,688 to Kren et al., which is incorporated by reference as if fully set forth herein.

The classification of the defects in the different sub-groups may be determined as described herein. For instance, the one or more characteristics of one or more defects in a sub-group may be compared to data in a defect library for different types of IL defects and different types of non-IL defects depending on the group from which the sub-group originates. Such a comparison may be performed as described herein. In addition, the one or more characteristics that are compared to classify the defects in the sub-groups may be different than or the same as the one or more characteristics that are compared to bin the defects into groups and/or the one or more characteristics that are compared to bin the defects into sub-groups. The defects in the sub-groups may also be classified using any other suitable algorithm and/or method. For example, the defects in the sub-groups may be classified using automatic defect classification (ADC) algorithms and/or methods.

In another embodiment, the method includes determining if the defects in the different sub-groups are systematic defects or nuisance defects. For example, as described above, the defects may be separated into sub-groups such that each of the defects in a sub-group has substantially the same one or more characteristics. In this manner, each sub-group may include systematic defects or nuisance defects. In one such embodiment, the defects in each sub-group may be determined to be systematic defects or nuisance defects collectively as a sub-group using either the one or more characteristics or any other information about one defect in the sub-group or the one or more characteristics or any other information about some or all of the defects in the sub-group (e.g., some value of the one or more characteristics of some or all of the defects in the sub-group such as a mean and/or standard deviation).

Determining if the defects in the different sub-groups are systematic defects or nuisance defects may also be performed as described herein. For instance, the one or more characteristics of one or more defects in a sub-group may be compared to data in a defect library for different types of IL defects and different types of non-IL defects depending on the group from which the sub-group originates. Such a comparison may be performed as described herein. In addition, the one or more characteristics that are compared to determine if the defects are systematic defects or nuisance defects may be different than or the same as the one or more characteristics that are compared to bin the defects into groups and/or the one or more characteristics that are compared to bin the defects into sub-groups.

The defects in the sub-groups may also be determined to be systematic defects or nuisance defects using any other suitable algorithm and/or method. For example, the defects in the sub-groups may be determined to be systematic defects or nuisance defects using pattern matching type methods such as those described in commonly assigned U.S. patent application Ser. No. 11/300,172 by Lin et al. filed Dec. 14, 2005, which is incorporated by reference as if fully set forth herein. In addition, the defects in the sub-groups may be identified as systematic defects or nuisance defects using location information (e.g., obtained via pattern matching) and one or more other characteristics of the defects. Furthermore, determining if the defects in the sub-groups are systematic defects or nuisance defects may be performed as described in commonly assigned U.S. Patent Application Ser. Nos. 60/737,947 by Zafar et al. filed Nov. 18, 2005 and 60/738,290 by Kulkarni et al. filed Nov. 18, 2005, both of which are incorporated by reference as if fully set forth herein.

In an additional embodiment, the method includes determining a root cause of the defects in the different sub-groups. For example, as described above, the defects may be separated into sub-groups such that each of the defects in a sub-group has substantially the same one or more characteristics. In this manner, each sub-group may include defects having the same root cause. In one such embodiment, the root cause of the defects in each sub-group may be determined collectively as a sub-group using either the one or more characteristics or any other information about one defect in the sub-group or the one or more characteristics or any other information about some or all of the defects in the sub-group (e.g., some value of the one or more characteristics of some or all of the defects in the sub-group such as a mean and/or standard deviation).

Determining the root cause of the defects in the different sub-groups may also be performed as described herein. For instance, the one or more characteristics of one or more defects in a sub-group may be compared to data in a defect library for different types of IL defects and different types of non-IL defects depending on the group from which the sub-group originates. Such a comparison may be performed as described herein. In addition, the one or more characteristics that are compared to determine the root cause of the defects may be different than or the same as the one or more characteristics that are compared to bin the defects into groups and/or the one or more characteristics that are compared to bin the defects into sub-groups. The root cause of the defects in the sub-groups may also be determined using any other suitable algorithm and/or method known in the art.

In a further embodiment, the method includes determining one or more actions that can be taken to reduce the defects on additional wafers. The one or more actions can be determined as described herein. In addition, the one or more actions may be determined to reduce a group of the defects, more than one group of the defects, a sub-group of the defects, more than one sub-group of the defects, or some combination thereof on additional wafers.

In another embodiment, the method includes determining one or more actions that can be taken to increase yield of a fabrication process that includes the IL process. The one or more actions can be determined as described herein. In addition, the one or more actions may be determined to increase yield based on a group of the defects, more than one group of the defects, a sub-group of the defects, more than one sub-group of the defects, or some combination thereof. Each of the embodiments of the method described above may include any other step(s) of any other method(s) described herein.

The method embodiments described herein may also include generating any other defect-related output that can be used to acquire knowledge about the defect formation mechanisms of the IL process. For example, the method embodiments described herein may include generating a pareto chart that illustrates how many defects were detected at a particular (x, y) location on the wafer. The pareto chart may alternatively illustrate how many defects of a particular classification, how many defects identified as systematic defects, how many defects identified as nuisance defects, or how many defects having a particular root cause are detected at a particular location on the wafer. Such output may be used to determine new types of defectivity that are being caused by the IL process.

The embodiments described herein provide a number of advantages. For example, the embodiments described herein may be used as an IL binner. The IL binner may be based on a currently used classification algorithm such as iDO configured such that IL defects are binned separately from non-IL defects. In addition, the embodiments may also incorporate SSA as part of the binner. For example, the iDO may be implemented as decision tree-based binning in which SSA forms the top level of the decision tree. In this manner, the defects may be separated based on SSA, and then the defects may be further separated based on other characteristic(s) of the defects.

These embodiments can be valuable for use in the IL technology ramp at the 65 nm and 45 nm technology nodes. For example, the binner can be used to reduce time to results for the inspection portion of the technology ramp. In addition, the embodiments described herein can be used to drive down the defectivity, reduce the learning curve, and increase the yield performance of the IL process at each user site. The embodiments described above are also advantageous for at least the reasons described above with respect to the additional embodiments described herein.

Further modifications and alternative embodiments of various aspects of the invention may be apparent to those skilled in the art in view of this description. For example, methods for determining information about defects or binning defects detected on a wafer after an IL process is performed on the wafer are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer-implemented method for determining information about a defect detected on a wafer after an immersion lithography process is performed on the wafer, comprising:
comparing inspection results for the defect to data in a defect library for different types of immersion lithography defects; and
determining the information about the defect based on results of said comparing.

2. The method of claim 1, wherein the inspection results comprise an image of the defect, and wherein the data comprises images of the different types of the immersion lithography defects.

3. The method of claim 1, wherein the inspection results comprise a signature of the defect, and wherein the data comprises signatures of the different types of the immersion lithography defects.

4. The method of claim 1, wherein the data comprises data for the different types of the immersion lithography defects for different values of parameters of the immersion lithography process.

5. The method of claim 1, wherein the defect library comprises data for different types of non-immersion lithography defects.

6. The method of claim 1, wherein the data comprises defect images generated by inspection, defect images generated by review, patch images, wafer maps, pareto charts, root cause information, or some combination thereof.

7. The method of claim 1, wherein the data comprises data acquired by inspection of other wafers, data determined from output of the inspection, or some combination thereof.

8. The method of claim 1, wherein the information comprises a classification of the defect.

9. The method of claim 1, wherein the information comprises identification of the defect as a systematic defect or a nuisance defect.

10. The method of claim 1, wherein the information comprises a root cause of the defect.

11. The method of claim 1, further comprising determining one or more actions that can be taken to reduce the defect on additional wafers.

12. The method of claim 1, further comprising determining one or more actions that can be taken to increase yield of a fabrication process that includes the immersion lithography process.

13. The method of claim 1, wherein the immersion lithography process comprises an exposure step during which water is in contact with the wafer.

14. The method of claim 1, wherein the immersion lithography process comprises an exposure step during which a liquid having a refractive index greater than the refractive index of water is in contact with the wafer.

15. A computer-implemented method for binning defects detected on a wafer after an immersion lithography process is performed on the wafer, comprising:
comparing one or more characteristics of the defects to one or more characteristics of immersion lithography defects and one or more characteristics of non-immersion lithography defects; and
binning the defects having one or more characteristics that substantially match the one or more characteristics of the immersion lithography defects and the non-immersion lithography defects in different groups.

16. The method of claim 15, wherein the one or more characteristics of the defects comprise feature vectors of the defects.

17. The method of claim 15, wherein the one or more characteristics of the defects comprise feature vectors of spatial signatures of the defects.

18. The method of claim 15, wherein the one or more characteristics of the immersion lithography defects comprise the one or more characteristics of the immersion lithography defects for different values of parameters of the immersion lithography process, and wherein the one or more characteristics of the non-immersion lithography defects comprise the one or more characteristics of the non-immersion lithography defects for the different values of the parameters of the immersion lithography process.

19. The method of claim 15, wherein the one or more characteristics of the immersion lithography defects and the non-immersion lithography defects are stored as data in a defect library.

20. The method of claim 19, wherein the defect library comprises defect images generated by inspection, defect images generated by review, patch images, wafer maps, pareto charts, root cause information, or some combination thereof.

21. The method of claim 15, wherein the one or more characteristics of the immersion lithography defects and the non-immersion lithography defects are determined from output acquired by inspection of other wafers.

22. The method of claim 15, further comprising binning the defects in one or more of the different groups into different sub-groups based on the one or more characteristics of the defects.

23. The method of claim 15, further comprising binning the defects in one or more of the different groups into different sub-groups based on the one or more characteristics of the defects and classifying the defects in the different sub-groups.

24. The method of claim 15, further comprising binning the defects in one or more of the different groups into different sub-groups based on the one or more characteristics of the defects and determining if the defects in the different sub-groups are systematic defects or nuisance defects.

25. The method of claim 15, further comprising binning the defects in one or more of the different groups into different sub-groups based on the one or more characteristics of the defects and determining a root cause of the defects in the different sub-groups.

26. The method of claim 15, further comprising determining one or more actions that can be taken to reduce the defects on additional wafers.

27. The method of claim 15, further comprising determining one or more actions that can be taken to increase yield of a fabrication process that includes the immersion lithography process.

28. The method of claim 15, wherein the immersion lithography process comprises an exposure step during which water is in contact with the wafer.

29. The method of claim 15, wherein the immersion lithography process comprises an exposure step during which a liquid having a refractive index greater than the refractive index of water is in contact with the wafer.
